(19) United States
(12) Patent Application Publication
(10) Pub. No.: US 2014/0359531 A1
(43) Pub. Date: Dec. 4, 2014

(54) METHOD, APPARATUS AND TERMINAL DEVICE FOR BROWSER NAVIGATION

(71) Applicant: Tencent Technology (Shenzhen) Company Limited, (unknown)

(72) Inventor: Guoyi XIANG, Shenzhen (CN)

(73) Assignee: Tencent Technology (Shenzhen) Company Limited

(21) Appl. No.: 14/195,776

(22) Filed: Mar. 3, 2014

Related U.S. Application Data
(63) Continuation of application No. PCT/CN2013/090043, filed on Dec. 20, 2013.

(30) Foreign Application Priority Data
May 31, 2013 (CN) 201310213789.4

(51) Int. Cl. G06F 3/0481; G06F 3/0484; G06F 3/0482

(52) U.S. Cl. CPC G06F 3/04817; G06F 3/0482; G06F 3/04842
USPC 715/835

(57) ABSTRACT

Method and device of displaying navigational content in a web interface are disclosed. The method includes: detecting a user input to start a navigation page of a web browser; acquiring circumstance information of the mobile device, wherein the circumstance information includes at least one of a current time, a location of the mobile device and a characteristic of a current data connection used by the mobile device; selecting a first plurality of Internet resources from a resource database based on the acquired circumstance information; creating navigational visual content for the first plurality of Internet resources based on the acquired circumstance information; and displaying the navigational visual content for the first plurality of Internet resources in the navigation page.

### RELATED APPLICATIONS

This application is a continuation application of PCT Patent Application No. PCT/CN2013/090043, entitled “METHOD, APPARATUS AND TERMINAL DEVICE FOR BROWSER NAVIGATION” filed Dec. 20, 2013, which claims priority to Chinese Patent Application No. 201310213789.4, “METHOD, APPARATUS AND TERMINAL DEVICE FOR BROWSER NAVIGATION”, filed May 31, 2013, both of which is hereby incorporated by reference in its entirety.

### FIELD OF THE INVENTION

The present disclosure relates to the field of Internet technology, and especially relates to a method, apparatus and terminal device for browser navigation.

### BACKGROUND OF THE INVENTION

At present, as smart phones become increasingly popular, surfing Internet through smart phones become part of people's daily lives. Browsers are an important tool for both a personal computer (PC) and a mobile phone. When a user uses a certain browser to visit the Internet, there is often a navigation page. The navigation page generally includes search, recommended websites and recommended content.

The navigation information in a navigation page is mostly provided by manual screening and configuration. And it does not make personalized adjustment according to the users' activity habits and interests. For example, FIG. 1 is a schematic view of one navigation interface and FIG. 2 is a schematic diagram of browser navigation interface of another browser. Thus, the available technology is unable to make personalized navigation recommendations to the users based on their individualized interests.

### SUMMARY

In some embodiments, a method of displaying navigational content in a web interface is performed at a mobile device having one or more processors and memory storing instructions for execution by the one or more processors. The method includes: detecting a user input to start a navigation page of a web browser; acquiring circumstance information of the mobile device, wherein the circumstance information includes at least one of a current time, a location of the mobile device and a characteristic of a current data connection used by the mobile device; selecting a first plurality of Internet resources from a resource database based on the acquired circumstance information; creating navigational visual content for the first plurality of Internet resources based on the acquired circumstance information; and displaying the navigational visual content for the first plurality of Internet resources in the navigation page.

In another aspect, a device comprises one or more processors, memory, and one or more program modules stored in the memory and configured for execution by the one or more processors. The one or more program modules include instructions for performing the method described above. In another aspect, a non-transitory computer readable storage medium having stored thereon instructions, which, when executed by a device, cause the device to perform the method described above.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

In order to explain the technical scheme in the embodiments of the present invention more clearly, the following will briefly introduce the drawings need to be used in the description of the embodiments, obviously, the drawings in the following description are only some embodiments of the present invention, for the common technicians of this field, they can also obtain other drawings according to these drawings without any creative labor.

FIG. 1 is a schematic diagram of a navigation interface provided by the conventional technology;

FIG. 2 is a schematic diagram of another navigation interface provided by the conventional technology;

FIG. 3 is a flowchart of a method of displaying navigational content in a web interface in accordance with some embodiments;

FIG. 4 is a schematic diagram of the navigation page realized by the browser navigation method in accordance with some embodiments;

FIG. 5 is a flowchart of a method of displaying navigational content in a web interface in accordance with some embodiments;

FIG. 6 is a schematic diagram of the navigation page realized by the browser navigation method in accordance with some embodiments;

FIG. 7 is a schematic structural diagram of a device of displaying navigational content in a web interface in accordance with some embodiments;

FIG. 8 is a structural diagram of the browser navigation apparatus in accordance with some embodiments;

FIG. 9 is a flowchart of a method of displaying navigational content in a web interface in accordance with some embodiments; and

FIG. 10 is a schematic structural diagram of a device of displaying navigational content in a web interface in accordance with some embodiments.

Like reference numerals refer to corresponding parts throughout the several views of the drawings.

### DESCRIPTION OF EMBODIMENTS

In order to make a clearer understanding of purpose, technical scheme and advantages of the present invention, the following will give further detailed description with reference to attached drawings and embodiments. It should be understood that the specific embodiment described herein is merely used to illustrate the present invention, rather than to limit the present invention.

In some embodiments, according to the historical activity record, a mobile device generates an interest pattern of the current user account, and obtains the navigation information in accordance with the interest pattern, loads the navigation template corresponding to the interest pattern in the navigation page of the browser, and displays the navigation information corresponding to the interest categories in the navigation page.

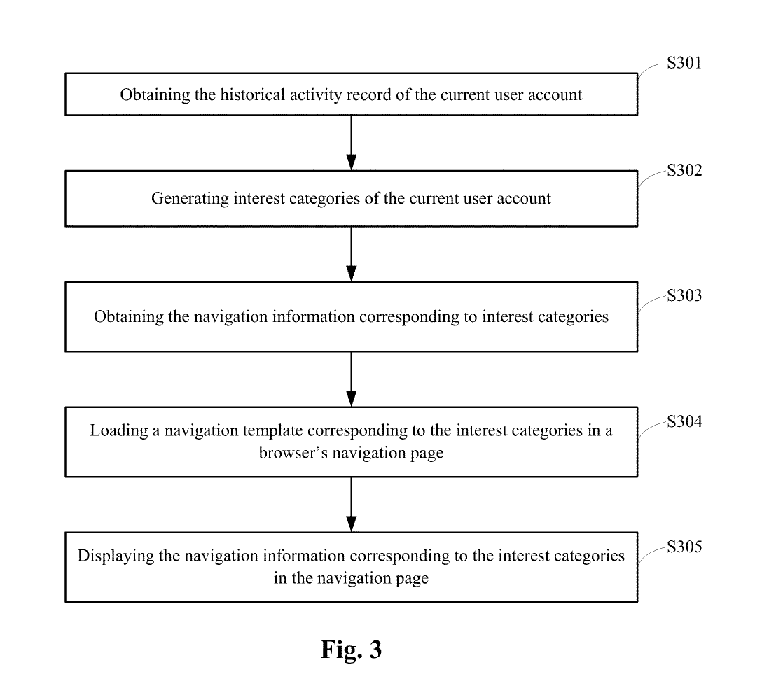

FIG. 3 shows a flowchart diagram of browser navigation method in accordance with some embodiments, the details are as follows:

In S301, a mobile device obtains the historical activity record of the current user account.

In some embodiments, the historical activity record includes the historical Internet activity data of the user account, e.g., the websites that are visited, the applications that are opened.

In S302, according to the historical activity record, the mobile device generates interest categories of the current user account.

In some embodiments, in order to be able to statistically generate the interest categories, the obtained historical activity record includes historical Internet activities within a preset time period. In some embodiments, when obtaining the historical activity record of the current user account, the mobile device also obtains the current circumstance information. In some embodiments, the mobile device generates the interest categories of the current user account according to the historical activity record as well as the current circumstance information.

In some embodiments, in order to meet the needs of real-time navigation, the mobile device obtains the most recent visited website when the user returns to the navigation page from another webpage. The mobile device then determines the interest category of the most recent visited website.

In some embodiments, there are one or more categories associated with a user account. For example, interest categories for a user account may include “Entertainment”, “Sports”, “Online-shopping”, etc.

In some embodiments, after the mobile device generates the interest categories by analyzing the historical activity record, the mobile device proceeds to S303.

In S303, according to the interest categories, the mobile device obtains the navigation information corresponding to the interest categories.

In some embodiments, the navigation information includes the navigation information related to the websites (e.g., Yahoo!, Washington Post), to content (e.g., trending news) and to applications (e.g., Skype, online games).

In S304, the mobile device loads a navigation template corresponding to the interest categories in a browser's navigation page.

In some embodiments, the mobile device configures various different navigation templates in advance. The mobile device selects navigation templates according to the different interest categories of different user accounts.

In S305, the mobile device displays the navigation information corresponding to the interest categories in the navigation page.

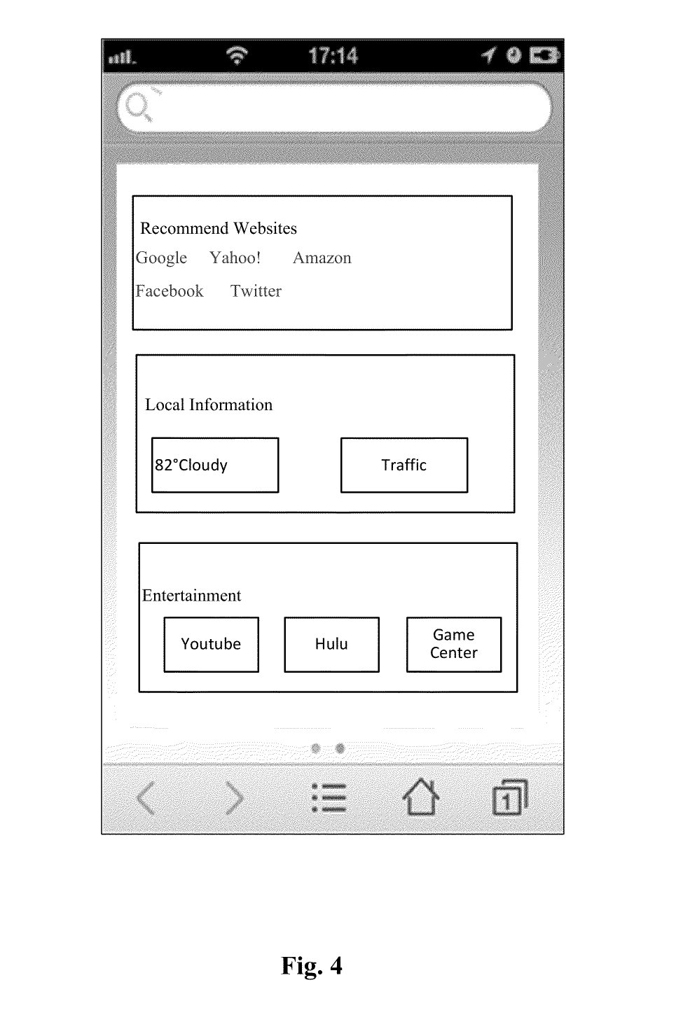

In some embodiments, different interest categories correspond to different navigation templates. FIG. 4 is the schematic diagram of navigation page realized based on the method in accordance with some embodiments. In some embodiments, the loaded navigation template includes two parts, local information and entertainment, and each part also includes different sub-module, e.g., YouTube and Hulu.

In some embodiments, the mobile device obtains the historical activity record of the current user account, generates the interest categories of the current user account, obtains the navigation information corresponding to the interest categories, loads the navigation template in the navigation page of the browser, and displays the navigation information in the navigation page.

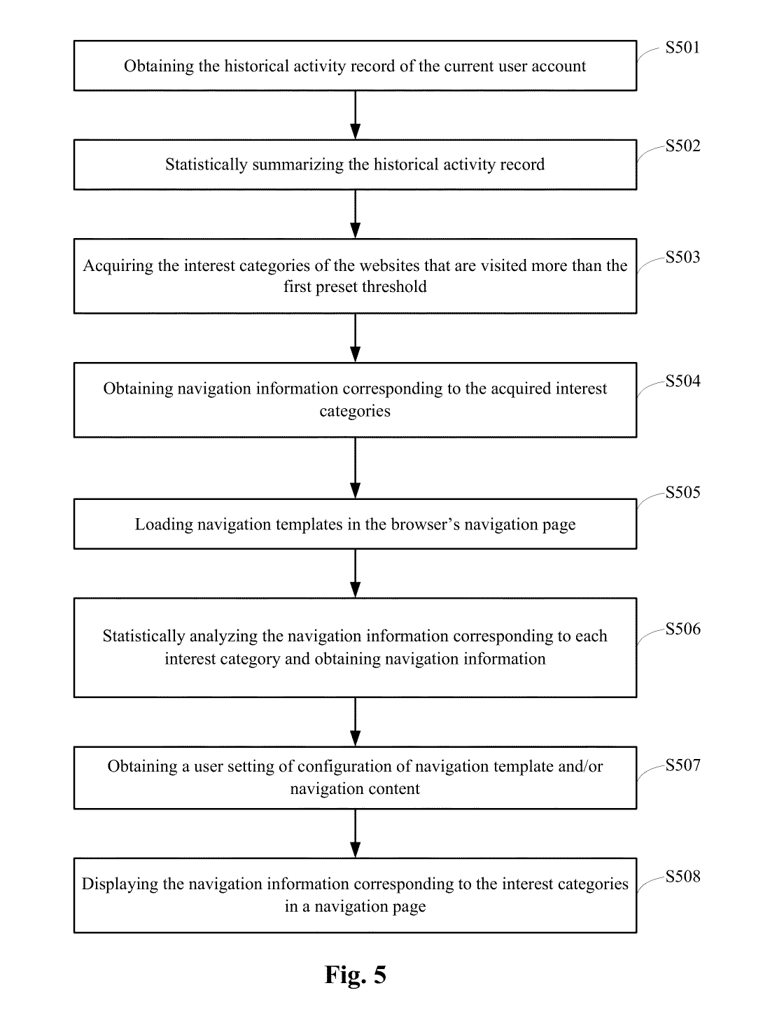

FIG. 5 shows a flowchart diagram of browser navigation method in accordance with some embodiments, the details are as follows:

In S501, the mobile device obtains the historical activity record of the current user account within a preset time period.

In S502, the mobile device statistically summarizes the historical activity record to determine that the total number of visits to an Internet resource exceeds a first preset threshold value.

In some embodiments, the mobile device statistically summarizes the historical activity record within a preset time period to determine that the total number of visits to an Internet resource exceeds a first preset threshold value. Please see Table 1. If the first preset threshold value is 5, the obtained navigation information includes “eBay” and “YellowCab”.

TABLE 1

| Access type | Access times |
|---|---|
| eBay | 10 |
| YellowCab | 6 |
| CNN | 4 |
| Tennis Time | 2 |
| . . . | |
| Internal Revenue Service | 1 |

In S503, the mobile device acquires the interest categories of the websites that are visited more than the first preset threshold.

In some embodiments, a preset classification table of users' interest categories stores the corresponding relations between various Internet resources and interest categories. The corresponding relations can be one-to-one, one-to-multiple, or multiple-to-one.

In S504, from the navigation content database, the mobile device obtains navigation information corresponding to the acquired interest categories.

In some embodiments, the navigation content database includes multiple types of navigation information. The navigation content database classifies the navigation information according to the interest categories. Each interest category can include multiple pieces of navigation information and each piece of navigation information can belong to multiple interest categories.

In some embodiments, in order to be able to produce personalized navigation information, before S504, the mobile device obtains the circumstance information of the current user account. In some embodiments, the circumstance information includes the access environment information, such as time, location and access network (e.g., Wi-Fi, 3G), and user identity information such as identity, age and hobbies. The identity information can be obtained from the registration information of the user account of the navigation websites or other websites.

In some embodiments, step S504 includes: from the navigation content database, the mobile device obtains navigation information corresponding to circumstance information and the acquired interest categories. Therefore, in the selection of the navigation information, the mobile device also takes into account the circumstance information.

The following is an example to facilitate understanding. If there is a user aged 30, whose usual time of visiting websites is from 5 PM to 7 PM, the user is likely to be an office worker. The navigation information for this user can be personalized for his/her work schedule and occupation. When the location of the mobile device changes, e.g., from Chicago to Dallas, the navigation information includes some recommend information related to Dallas, such as local restaurants and entertainment. In contrast, when a user of 16 year old starts the browser in the weekend, the navigational information can be basketball.

In S505, the mobile device loads navigation templates corresponding to the interest categories in the browser's navigation page.

In some embodiments, the navigation template corresponding to the interest categories can be generated in real time or in advance. Each interest category can correspond to multiple navigation templates and each navigation template can correspond to multiple interest categories. A user can select his/her favorite template for any particular interest category. FIG. 6 is the navigation page presented after the navigation page in FIG. 4 is adjusted by the user.

In some embodiments, the navigation templates can be loaded to the existing navigation page. In order to have enough space, the mobile device can decrease or reduce the existing navigation information.

In S506, the mobile device statistically analyzes the navigation information corresponding to each interest category and obtains navigation information that is visited more than a second preset number of times (e.g., a second preset threshold value). In the navigation template corresponding to each interest category, the mobile device displays the navigation information that is visited more times than a second preset threshold value is displayed in an order from the most to the least times of visit.

If certain navigation information is visited more times than a second preset threshold value, it indicates that this navigation information is the one that many users usually access. In addition, the displaying order by visit times personalizes navigation page. The first and second preset threshold values can be either the same or different.

In some embodiments, a user can modify the navigation template or navigation content by himself/herself.

In S507, the mobile device obtains a user setting of configuration of navigation template and/or navigation content.

In some embodiments, in accordance with user settings, the mobile device displays key combinations for moving and selecting templates. In addition, a user can modify the navigation template and navigation content, including, background, font, text style, etc. The mobile device can also delete and add navigation information in accordance with user instructions.

In S508, according to the configuration parameter, display the navigation information corresponding to the interest categories in a navigation page.

Optionally, the mobile device obtains the most recently visited website when the user returns to the navigation page from another webpage. The mobile device then analyzes the interest category of the previous webpage to recommend navigation information for the users in accordance with steps S504 to S508. For example, after a user searches for a classic novel online, when the user exits the searching page and enters the navigation page, the mobile device directly displays the column of “Classic novels” recommended by the system in the navigation page.

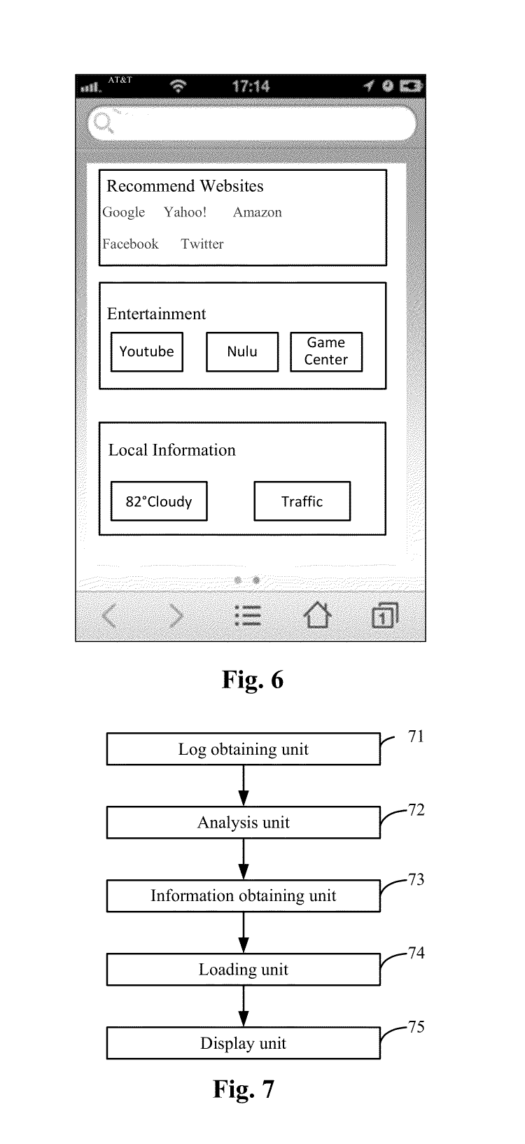

FIG. 7 shows the structure of the system of browser navigation apparatus in accordance with some embodiments.

The apparatus includes: record obtaining unit 71, analysis unit 72, information obtaining unit 73, loading unit 74 and display unit 75.

Record obtaining unit 71 is configured to obtain the historical activity record of the current user account. Optionally, the record obtaining unit 71 is specifically configured to obtain the historical activity record of the current user account within a preset time period.

Analysis unit 72 is configured to generate the interest categories according to the historical activity record. The analysis unit 72 is configured to statistically analyze the historical activity record to determine that the total number of visits to an Internet resource exceeds a first preset threshold value.

Information obtaining unit 73 is configured to obtain the navigation information corresponding to the interest categories.

Loading unit 74 is configured to load navigation templates corresponding to the interest categories in the browser's navigation page.

Display unit 75 is configured to display the navigation information in the navigation templates.

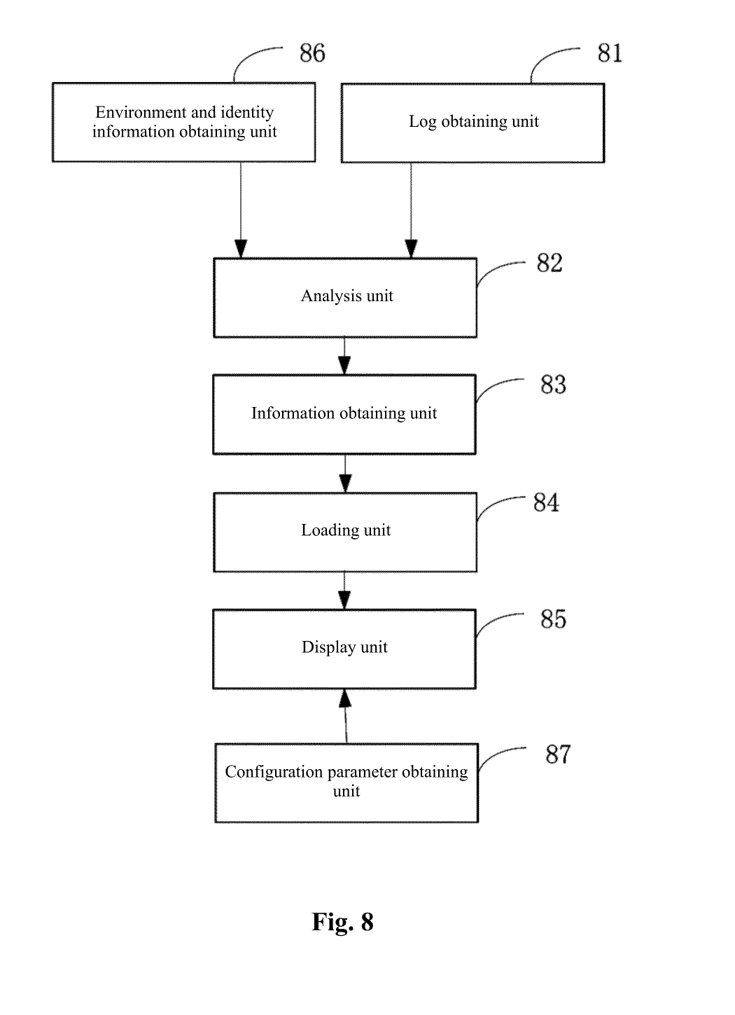

FIG. 8 shows the structure of the system of browser navigation apparatus in accordance with some embodiments.

The apparatus includes: record obtaining unit 81, analysis unit 82, information obtaining unit 83, loading unit 84, display unit 85, circumstance information obtaining unit 86 and configuration obtaining unit 87.

The units in FIG. 8 have functions in addition to those of the similar units in FIG. 7.

The record obtaining unit 81 is also configured to obtain the most recently historical activity record.

The analysis unit 82 is also configured to analyze the interest categories according to the most recent historical activity record.

The information obtaining unit 83 is also configured to obtain the navigation information corresponding to the interest categories.

The circumstance information obtaining unit 86 is configured to obtain the circumstance information.

The information obtaining unit 83 is also configured to obtain the navigation information corresponding to the circumstance information.

The display unit 85 is specifically configured to display the navigation information of Internet resources that are visited more than the second preset threshold value.

Configuration obtaining unit 87 is configured to obtain a user setting of configuration of navigation template and/or navigation content.

The display unit 86 is also configured to display the navigation information in the navigation template.

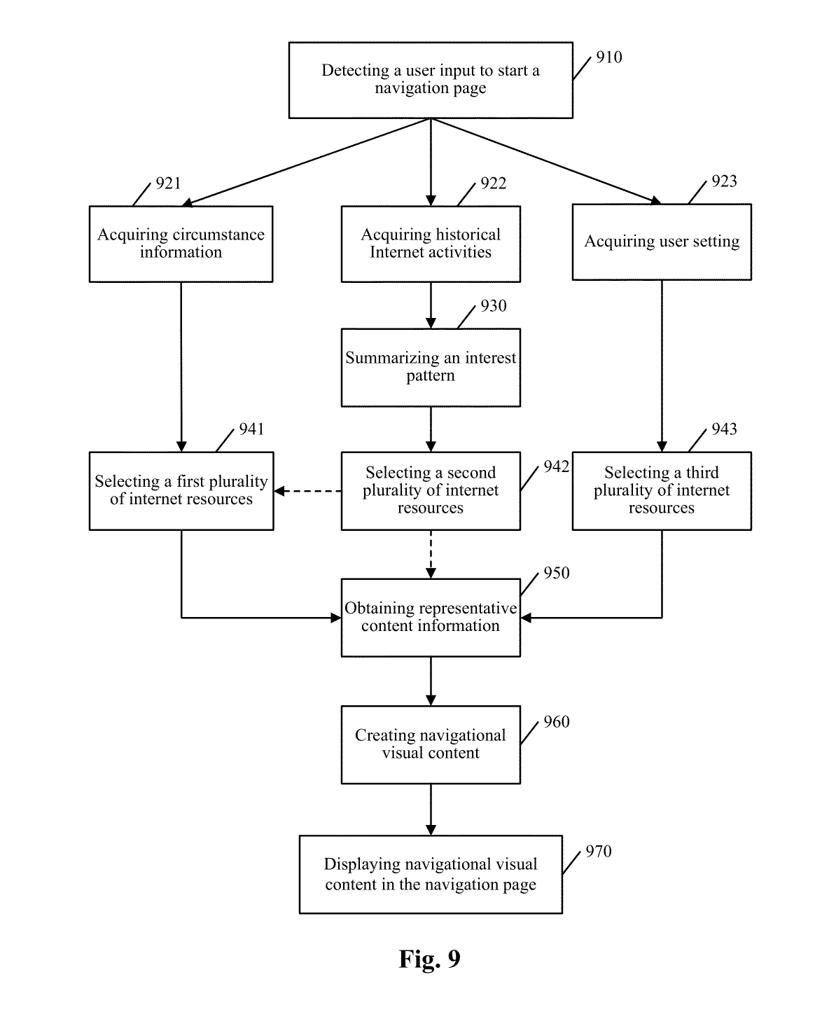

FIG. 9 is a flowchart of a method displaying navigational content in a web interface in accordance with some embodiments. The method is performed at a device having one or more processors and memory storing instructions for execution by the one or more processors. Other details of the method shown in FIG. 9 are described above.

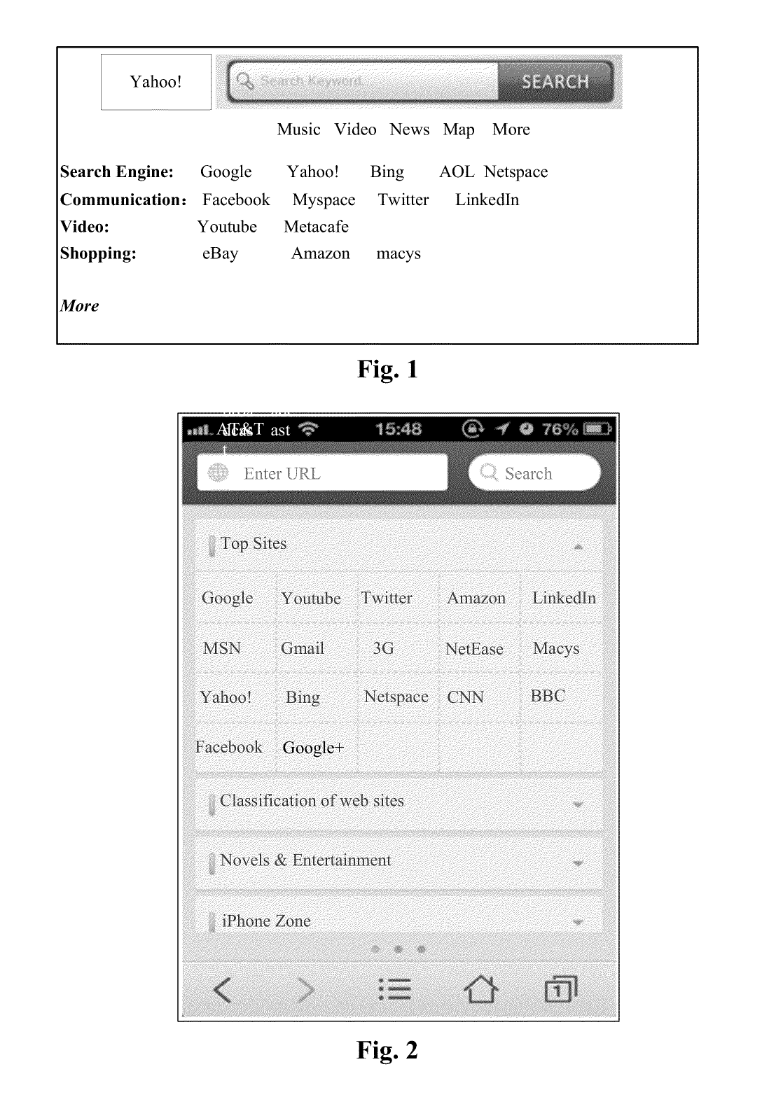

In step 910, the mobile device detects a user input to start a navigation page of a web browser. The mobile device can be a smart phone, a hand-held computer, a table computer or any device that can be carried with. In some embodiments, the navigation page is the default page that is opened when a web browser starts. In some embodiments, the navigation page is bookmarked and is opened after a user starts a web browser. In some embodiments, there is more than one tab that is opened in a web brewer and the default new tab is the navigation page. FIGS. 1-2, 4 and 6 show examples of navigation pages.

In some embodiments, a navigation page contains navigational visual content. In some embodiments, the navigational visual content includes icons, texts, images, and so on. When navigational visual content is selected, the mobile device visits one or more Internet resources to acquire more content data. In some embodiments, a selection of navigational visual content leads to opening a new page of a website. In some embodiments, a selection of navigational visual content opens an application, which can be web-based application or not.

After step 910, the mobile device carries out one or more of steps 921, 922 and 923 in accordance with various embodiments.

In some embodiments, in step 921, the mobile device acquires circumstance information of the mobile device, wherein the circumstance information includes at least one of a current time, a location of the mobile device and a characteristic of a current data connection used by the mobile device. In some embodiments, the location of the mobile device is acquired from a GPS system or a radio positioning system. In some embodiments, the characteristic of the current data connection includes a type of current data connection technology, such as GSM, CDMA2000, WCDMA, Wi-Fi, USB, Ethernet, etc. In some embodiments, the characteristic of the current data connection includes a bandwidth of the current data connection. In some embodiments, the characteristic of the current data connection includes a wireless signal quality. Other characteristics affecting data transmission quality, speed, cost, time, etc. may be considered as part of the circumstance information.

In some embodiments, the mobile device proceeds to step 931 after step 921. In some embodiments, in step 931, the mobile device selects a first plurality of Internet resources from a resource database based on the acquired circumstance information.

In some embodiments, the resource database includes names, URLs, categories, and other characteristics of Internet resources. In some embodiments, the resource database is located at a local storage device of the mobile device. In some embodiments, the resource database is located at a remote server and is accessed by data connection.

In some embodiments, the mobile device selects Internet resources based on the current time. For example, an Internet resource providing traffic condition is selected when the current time is close to the time that a user leaves office for home from Monday to Friday. For another example, an Internet resource providing real time financial market data is selected only in workdays, when financial markets open.

In some embodiments, the mobile device selects Internet resources based on the current location. For example, an Internet resource providing map service is selected when the acquired current location shows that the mobile device is outside of its normal area of location. As a result, local interests are recommended to the user who is likely to be a traveler.

In some embodiments, the mobile device selects Internet resources based on the characteristic of the data connection that is currently used by the mobile device. For example, a game website that consumes lots of data is selected only when the mobile device is connected with Wi-Fi and data usage is free. In some embodiments, the selecting the first plurality of resources is based on typical data transmission requirements of the first plurality of resources and the bandwidth of the current data connection. For example, when the bandwidth of the data connection is low, a website providing novels is favored against a website providing high quality stream videos.

In some embodiments, the mobile device proceeds to step 922. In some embodiments, in step 922, the mobile device acquires historical Internet activities of a user account of the mobile device. In some embodiments, the historical Internet activities include websites that have been visited by the user account and respective time and duration of each visit to each of the websites. In some embodiments, the historical Internet activities include applications that have been used to visit the Internet and respective time and duration of each use of each of the applications. In some embodiments, there is a limitation on how long ago of the historical Internet activities should be acquired. In some embodiments, the historical Internet activities include the position information of the mobile device when the mobile device visits a website or uses an application.

In some embodiments, in step 930, the mobile device summarizes an interest pattern of the user account based on the historical Internet activities. In some embodiments, the interest pattern is used to predict a user's preference for the navigation page.

In some embodiments, the interest pattern includes a score for each of a plurality of Internet resources. In some embodiments, the score represents the likelihood that a user is interested in seeing an Internet resource in the navigation page. In some embodiments, the interest pattern is generated from a statistical model analyzing the historical Internet activities.

A description of an example method of generating an interest pattern in accordance with some embodiments is described in the following. First, all visited Internet resources, including websites, are assigned into predefined categories. Categories can include interest categories and ones according to other criteria. One Internet resource can be assigned to more than categories. For example, ESPN is assigned into both sport category and live video category. Second, each predefined categories is given a weighting factor. The weighting factor of a category corresponds to the frequency and duration of visits to Internet resources within that category. In some embodiments, in addition, a more recent visit has bigger influence on the weighting factor than an older visit. A decay algorithm can be employed to achieve variation of influence by time. Third, a score for each recommended Internet resource is generated based on the weighting factor of the categories that the Internet resource belongs and the frequency of visits to the particular Internet resource.

In some embodiments, the interest pattern is associated with circumstance information. For example, according to the historical activity record, the mobile device visits a weather website everyday at approximately 8 am but not at other times of the day. The interest pattern includes that a time-dependent score of a weather service. For another example, a user visits YouTube only at home and the interest pattern includes a position-dependent score of YouTube.

In some embodiments, after step 930, the mobile device proceeds to step 942. In some embodiments, at step 942, the mobile device selects a second plurality of resources from the resource database based on the interest pattern. In some embodiments, the mobile device selects the Internet resources with the highest scores.

In some embodiments, the mobile device selects the Internet resources based on the acquired circumstance information in addition to the interest pattern. When the interest pattern is associated with circumstance information, taking into account the acquired current circumstance information improves the quality of the selection.

In some embodiments, after step 942, the mobile device proceeds to step 941. In some embodiments, from the second plurality of resources, the mobile device selects some or all of the first plurality of resources. For example, the interest pattern recommends a streaming video website that is not supported by the current data connection. As a result, the streaming video website is included in the second plurality but not the first plurality of websites.

In some embodiments, in step 923, the mobile device acquires a previous setting of a user account. In some embodiments, the previous user setting includes one or more Internet resources that a user wants to place in the navigation page.

In some embodiments, in step 943, the mobile device selects third plurality of Internet resources from the resource database based on the previous setting of a user account. In some embodiments, the previous setting of the user account specifies at least one Internet resource that is to be selected only when the acquired circumstance information meets predefined criteria. In some embodiments, the predefined criteria include a predefined time of a day. For example, the previous setting may include that a bar rating website is selected only after 7 pm in everyday.

In some embodiments, after one or more steps 941-943, the mobile device proceeds to step 950. In some embodiments, at step 950, the mobile obtains representative content information for the first, second, and/or third plurality of Internet resources. In some embodiments, for some Internet resources, the navigational visual content is stored in a local storage device. For example, a music application has an icon as the representative content information and the icon is stored in the local storage device. In some embodiments, for at least one the Internet resources, the mobile device obtains representative content information from that Internet resource instead of the local storage device. For example, a weather service shows the current temperature as the representative content information, which is obtained from the Internet resource of the weather service.

In some embodiments, the mobile device selectively obtains one of multiple versions of representative content information from at least one of the first plurality of Internet resources based on respective data sizes of the multiple versions and the characteristic of the current data connection. For example, if the representative content information has both an image version and a text version, the mobile device may selectively obtains the text version because the image version costs data amount and may be slow to download.

In some embodiments, at step 960, the mobile device creates navigational visual content for the first, second and/or third plurality of Internet resources from the obtained representative content information.

In some embodiments, at step 970, the mobile device displays the navigational visual content for the first, second and/or third plurality of Internet resources in the navigation page. In some embodiments, the position of the visual content of an Internet resource is associated with the score of the Internet resource in the interest pattern.

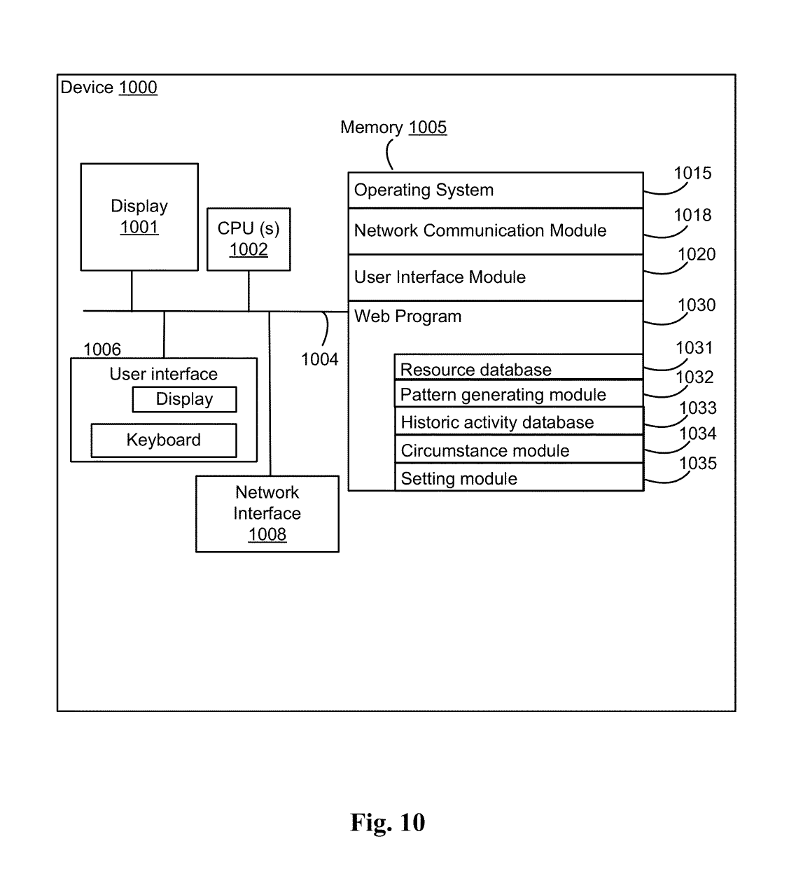

FIG. 10 is a diagram of an example implementation of 1000 in accordance with some embodiments. In some embodiments, the device 1000 includes one or more processing units (CPU's) 1002, one or more network or other communications interfaces 1008, a display 1001, memory 1005, and one or more communication buses 1004 for interconnecting these and various other components. The communication buses may include circuitry (sometimes called a chipset) that interconnects and controls communications between system components. The memory 1005 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 1005 may optionally include one or more storage devices remotely located from the CPU(s) 1002. The memory 1005, including the non-volatile and volatile memory device(s) within the memory 1005, comprises a non-transitory computer readable storage medium.

In some implementations, the memory 1005 or the non-transitory computer readable storage medium of the memory 1005 stores the following programs, modules and data structures, or a subset thereof including an operating system 1015, a network communication module 1018, a user interface module 1020, and a web program 1030.

The operating system 1015 includes procedures for handling various basic system services and for performing hardware dependent tasks.

The network communication module 1018 facilitates communication with other devices via the one or more communication network interfaces 1008 (wired or wireless) and one or more communication networks, such as the Internet, other wide area networks, local area networks, metropolitan area networks, and so on.

The user interface module 1020 is configured to receive user inputs through the user interface 1006.

The web browser 1030 is configured to display a navigation page with navigational visual content. The web browser 1030 comprises a resource database 1031, a pattern generating module 1032, a historical activity database 1033, a circumstance module 1034, and a setting module 1035. The resource database 1031 is configured to store names, URLs, categories, and other characteristics of Internet resources. The pattern generating module is configured to summarize an interest pattern of the user account based on the historical Internet activities acquired from the historical activity database 1033. The historical activity database 1033 is configured to store historical Internet activities of one or more user accounts. The circumstance module is configured to acquire circumstance information from other modules and programs of the device 1000 and to select Internet resources based on the acquired circumstance information. The setting module is configured to store setting of one or more user accounts and select Internet based on the stored setting. The web browser 1030 optionally includes other modules and sub-modules for performing other operations described above with respect to various embodiments.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

What is claimed is:

1. A method of displaying navigational content in a web interface, comprising:
at a mobile device having one or more processors and memory:
detecting a user input to start a navigation page of a web browser;
acquiring circumstance information of the mobile device, wherein the circumstance information includes at least one of a current time, a location of the mobile device and a characteristic of a current data connection used by the mobile device;
selecting a first plurality of Internet resources from a resource database based on the acquired circumstance information;
creating navigational visual content for the first plurality of Internet resources based on the acquired circumstance information; and
displaying the navigational visual content for the first plurality of Internet resources in the navigation page.

2. The method of claim 1, further comprising:
acquiring historical Internet activities of a user account of the mobile device;
summarizing an interest pattern of the user account based on the historical Internet activities;
selecting a second plurality of resources from the resource database based on the interest pattern;
creating second navigational visual content for the second plurality of Internet resources based on the interest pattern; and
displaying the second navigational visual content with the first navigational visual content in the navigation page.

3. The method of claim 2, wherein the historical Internet activities include websites that have been visited by the user account and respective time and duration of each visit to each of the websites.

4. The method of claim 2, wherein the historical Internet activities include applications that have been used to visit the Internet and respective time and duration of each use of each of the applications.

5. The method of claim 2, wherein the interest pattern is associated with the circumstance information.

6. The method of claim 1, wherein the characteristic of the current data connection includes a type of current data connection technology.

7. The method of claim 1, wherein the characteristic of the current data connection includes a bandwidth of the current data connection.

8. The method of claim 1, wherein creating the navigational visual content for the first plurality of Internet resources further comprise:
obtaining representative content information from at least one of the first plurality of the Internet resources; and
creating the navigational visual content based on the obtained representative content information.

9. The method of claim 8, further comprising:
selectively obtaining one of multiple versions of representative content information from at least one of the first plurality of Internet resources based on respective data sizes of the multiple versions and the characteristic of the current data connection.

10. The method of claim 1, further comprising:
selecting a third plurality of Internet resources from the resource database based on a previous setting of a user account, wherein the previous setting of the user account specifies at least one Internet resource that is to be selected only when the acquired circumstance information meets predefined criteria.

11. A device of displaying navigational content in a web interface, comprising:
one or more processors; and
memory storing one or more programs for execution by the one or more processors, the one or more programs including instructions for:
detecting a user input to start a navigation page of a web browser;
acquiring circumstance information of the mobile device, wherein the circumstance information includes at least one of a current time, a location of the mobile device and a characteristic of a current data connection used by the mobile device;
selecting a first plurality of Internet resources from a resource database based on the acquired circumstance information;
creating navigational visual content for the first plurality of Internet resources based on the acquired circumstance information; and
displaying the navigational visual content for the first plurality of Internet resources in the navigation page.

12. The device of claim 11, wherein the one or more program modules further include instructions for:
acquiring historical Internet activities of a user account of the mobile device;
summarizing an interest pattern of the user account based on the historical Internet activities;
selecting a second plurality of resources from the resource database based on the interest pattern;
creating second navigational visual content for the second plurality of Internet resources based on the interest pattern; and
displaying the second navigational visual content with the first navigational visual content in the navigation page.

13. The device of claim 12, wherein the historical Internet activities include websites that have been visited by the user account and respective time and duration of each visit to each of the websites.

14. The device of claim 12, wherein the historical Internet activities include applications that have been used to visit the Internet and respective time and duration of each use of each of the applications.

15. The device of claim 11, wherein the characteristic of the current data connection includes a type of current data connection technology.

16. The device of claim 11, wherein the characteristic of the current data connection includes a bandwidth of the current data connection.

17. The device of claim 11, wherein creating the navigational visual content for the first plurality of Internet resources further comprise:
obtaining representative content information from at least one of the first plurality of the Internet resources; and
creating the navigational visual content based on the obtained representative content information.

18. The device of claim 17, wherein the one or more program modules further include instructions for:
selectively obtaining one of multiple versions of representative content information from at least one of the first plurality of Internet resources based on respective data sizes of the multiple versions and the characteristic of the current data connection.

19. The device of claim 11, wherein the one or more program modules further include instructions for:
selecting a third plurality of Internet resources from the resource database based on a previous setting of a user account, wherein the previous setting of the user account specifies at least one Internet resource that is to be selected only when the acquired circumstance information meets predefined criteria.

20. A non-transitory computer-readable storage medium having instructions stored thereon, the instructions, when executed by one or more processors, cause the processors to perform operations comprising:
detecting a user input to start a navigation page of a web browser;
acquiring circumstance information of the mobile device, wherein the circumstance information includes at least one of a current time, a location of the mobile device and a characteristic of a current data connection used by the mobile device;
selecting a first plurality of Internet resources from a resource database based on the acquired circumstance information;
creating navigational visual content for the first plurality of Internet resources based on the acquired circumstance information; and
displaying the navigational visual content for the first plurality of Internet resources in the navigation page.
